(19) United States
(12) Patent Application Publication
(10) Pub. No.: US 2019/0104022 A1
(43) Pub. Date: Apr. 4, 2019

(54) POLICY-BASED NETWORK SERVICE FINGERPRINTING

(71) Applicant: Intel Corporation, Santa Clara, CA (US)

(72) Inventors: Damien Power, Clare (IE); Patrick Fleming, Laois (IE); Michael J. McGrath, Cavan (IE); Jonathan Kenny, Tipperary (IE); David Hunt, Meelick (IE)

(73) Assignee: Intel Corporation, Santa Clara, CA (US)

(21) Appl. No.: 15/721,373

(22) Filed: Sep. 29, 2017

(51) Int. Cl. H04L 12/24; H04L 29/08

(52) U.S. Cl. CPC H04L 41/0893; H04L 41/0806; H04L 67/12

(57) ABSTRACT

A data center orchestrator, including: a hardware platform; a host fabric interface to communicatively couple the orchestrator to a network; an orchestrator engine to provide a data center orchestration function; and a data structure, including a network function virtualization definition (NFVD) instance, the NFVD instance including a definition for instantiating a virtual network function (VNF) on a host platform, including a telemetry fingerprint policy description (TFPD) for the VNF, wherein the TFPD includes information to collect telemetry data selected from a set of available telemetry data for the host platform.

### FIELD OF THE SPECIFICATION

This disclosure relates in general to the field of cloud computing, and more particularly, though not exclusively, to a system and method for policy-based network service fingerprinting.

### Background

In some modern data centers, the function of a device or appliance may not be tied to a specific, fixed hardware configuration. Rather, processing, memory, storage, and accelerator functions may in some cases be aggregated from different locations to form a virtual “composite node.” A contemporary network may include a data center hosting a large number of generic hardware server devices, contained in a server rack for example, and controlled by a hypervisor. Each hardware device may run one or more instances of a virtual device, such as a workload server or virtual desktop.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a block diagram of selected components of a data center with network connectivity, according to one or more examples of the present specification.

FIG. 2 is a block diagram of selected components of an end-user computing device, according to one or more examples of the present specification.

FIG. 3 is a block diagram of a network function virtualization (NFV) architecture, according to one or more examples of the present specification.

FIG. 4 is a block diagram of an example computing system, according to one or more examples of the present specification.

FIG. 5 is a flowchart of a method performed according to embodiments of the present specification.

FIG. 6 is a block diagram of components of a computing platform according to one or more examples of the present specification.

FIG. 7 is a block diagram of a central processing unit (CPU), according to one or more examples of the present specification.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

A contemporary computing platform, such as a hardware platform provided by Intel® or similar, may include a capability for monitoring device performance and making decisions about resource provisioning. For example, in a large data center such as may be provided by a cloud service provider (CSP), the hardware platform may include rackmounted servers with compute resources such as processors, memory, storage pools, accelerators, and other similar resources. As used herein, “cloud computing” includes network-connected computing resources and technology that enables ubiquitous (often worldwide) access to data, resources, and/or technology. Cloud resources are generally characterized by great flexibility to dynamically assign resources according to current workloads and needs. This can be accomplished, for example, via virtualization, wherein resources such as hardware, storage, and networks are provided to a virtual machine (VM) via a software abstraction layer, and/or containerization, wherein instances of network functions are provided in “containers” that are separated from one another, but that share underlying operating system, memory, and driver resources. Contemporary Intel® processors in particular provide specialized hardware support for gathering platform metrics, such as the Intel® resource director technology (RDT), which exposes valuable insight into properties such as last level cache (LLC) usage and memory throughput.

These properties may be used to determine how burdened a platform device is, and thus may be used to make decisions about whether and when to allocate additional compute resources so that devices do not become bottlenecks.

Such decisions are commonly made at the hardware platform level. But with the increased use of software defined networking (SDN), and particularly with the increased use of network function virtualization (NFV), the performance of a virtual network function (VNF) itself can have a significant impact on efficiency and resource utilization. Furthermore, while the hardware platform may provide a host of useful platform metrics, not all of these metrics are equally applicable to each VNF. For example, a general compute host may benefit from different metrics than a large distributed storage controller, which may benefit from different metrics than a memory server serving 3D Crosspoint (3DXP) fast persistent memory. Thus, if metrics are being collected for the hardware platform as a whole, those metrics may not be optimized for the individual workloads. Furthermore, if more than one VNF is being hosted on the same physical platform, which is often the case in a contemporary data center, then platform metrics alone may not give the most useful data for each VNF workload.

Embodiments of the present specification provide for network service or VNF-specific fingerprinting policies for the collection of runtime metrics. The policy may include, by way of nonlimiting example, specific network function virtualization infrastructure (NFVI) metrics, and metrics specific to a platform (such as Intel® architecture) that are used at the deployment, in addition to a runtime to personalize a metric collection for the given VNF. The collected metrics may be used by a fingerprint analytics module (FAM) to monitor and correct issues affecting the VNF or service.

Embodiments of the FAM of the present specification interoperate with existing telemetry systems. Existing telemetry systems may collect and process large amounts of metrics and events that are exposed at high-frequency from a platform, but that are not personalized for a given service. Large quantities of data are stored and analyzed, and meaningful information may be extracted from these in some embodiments.

Embodiments of the present specification improve on this process by providing personalized metric fingerprints of a VNF or service based, for example, on a service assurance-related context of interest such as throughput, latency, jitter, or any other desirable metric. This reduces the number of metrics that are collected and monitored with respect to any particular VNF. Rather, the metrics may be collected on a per-VNF basis to support unique VNF-specific service component analysis. In an embodiment, the FAM compares the fingerprint for a network service against a known good fingerprint for a given context, for example throughput, latency, jitter, or other. The fingerprint provides a mechanism to encapsulate the complexities and multiple facets of a complete service stack and VNF service interactions into a single representation. This may provide advantages over approaches that use individual or atomic metrics.

For example, multiple metrics may be combined to produce a synthetic composite metric (i.e., a fingerprint) that represents a fingerprint of the system under normal operational conditions while delivering a required level of service assurance. The synthetic metric or fingerprint may be repetitively calculated over a time window to produce a pattern of service behavior that can be used for comparison purposes against the fingerprint. Other approaches for comparing service metrics include radar plots across multiple platform vectors such as memory, CPU utilization, network input/output (I/O) or frequency domain distributions, by way of nonlimiting example. In some embodiments, when the synthetic fingerprint varies from a baseline by a certain degree, for example, such as by a certain number of standard deviations, then an alert may be raised, and corrective action may be taken.

Embodiments of the FAM of the present specification include the ability to embody the FAM in various different physical formats. For example, the FAM could be an application-specific integrated circuit (ASIC) or field-programmable gate array (FPGA) with a dedicated function, or could be a software module running on the host platform or on a dedicated virtual machine itself. In some embodiments, the FAM may be or include a hardware accelerator. The FAM could also include instructions encoded on one or more non-transitory, tangible computer readable mediums, including nonvolatile storage, flash, a read-only memory (ROM), instructions for programming an FPGA, an FPGA itself, or logic encoded directly into hardware such as in an ASIC. In embodiments that include an FPGA or an ASIC, one advantage is extremely high-speed comparison of fingerprints to baselines, and support for scalability including the ability to compare multiple fingerprints that examine different aspects of service performance in near real-time.

A system and method for policy-based network service fingerprinting will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

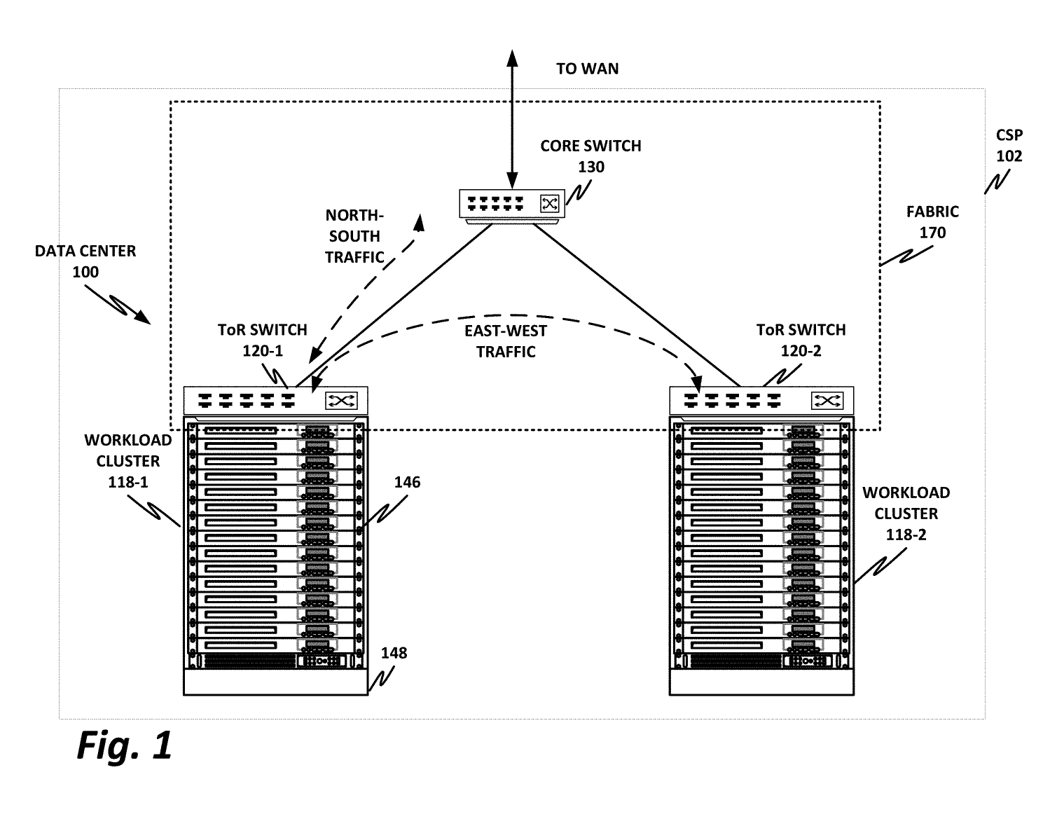

FIG. 1 is a block diagram of selected components of a data center with connectivity to network 100 of a cloud service provider (CSP) 102, according to one or more examples of the present specification. CSP 102 may be, by way of nonlimiting example, a traditional enterprise data center, an enterprise “private cloud,” or a “public cloud,” providing services such as infrastructure as a service (IaaS), platform as a service (PaaS), or software as a service (SaaS).

CSP 102 may provision some number of workload clusters 118, which may be clusters of individual servers, blade servers, rackmount servers, or any other suitable server topology. In this illustrative example, two workload clusters, 118-1 and 118-2 are shown, each providing rackmount servers 146 in a chassis 148.

In this illustration, workload clusters 118 are shown as modular workload clusters conforming to the rack unit (“U”) standard, in which a standard rack, 19 inches wide, may be built to accommodate 42 units (42 U), each 1.75 inches high and approximately 36 inches deep. In this case, compute resources such as processors, memory, storage, accelerators, and switches may fit into some multiple of rack units from one to 42.

Each server 146 may host a standalone operating system and provide a server function, or servers may be virtualized, in which case they may be under the control of a virtual machine manager (VMM), hypervisor, and/or orchestrator, and may host one or more virtual machines, virtual servers, or virtual appliances. These server racks may be collocated in a single data center, or may be located in different geographic data centers. Depending on the contractual agreements, some servers 146 may be specifically dedicated to certain enterprise clients or tenants, while others may be shared.

The various devices in a data center may be connected to each other via a switching fabric 170, which may include one or more high speed routing and/or switching devices. Switching fabric 170 may provide both “north-south” traffic (e.g., traffic to and from the wide area network (WAN), such as the internet), and “east-west” traffic (e.g., traffic across the data center). Historically, north-south traffic accounted for the bulk of network traffic, but as web and NFV-based network services become more complex and distributed, the volume of east-west traffic has risen. In many data centers, east-west traffic now accounts for the majority of traffic.

Furthermore, as the capability of each server 146 increases, traffic volume may further increase. For example, each server 146 may provide multiple processor slots, with each slot accommodating a processor having four to eight cores, along with sufficient memory for the cores. Thus, each server may host a number of VMs, each generating its own traffic.

To accommodate the large volume of traffic in a data center, a highly capable switching fabric 170 may be provided. Switching fabric 170 is illustrated in this example as a “flat” network, wherein each server 146 may have a direct connection to a top-of-rack (ToR) switch 120 (e.g., a “star” configuration), and each ToR switch 120 may couple to a core switch 130. This two-tier flat network architecture is shown only as an illustrative example. In other examples, other architectures may be used, such as three-tier star or leaf-spine (also called “fat tree” topologies) based on the “Clos” architecture, hub-and-spoke topologies, mesh topologies, ring topologies, or 3-D mesh topologies, by way of nonlimiting example.

The fabric itself may be provided by any suitable interconnect. For example, each server 146 may include an Intel® Host Fabric Interface (HFI), a network interface card (NIC), or other host interface. The host interface itself may couple to one or more processors via an interconnect or bus, such as PCI, PCIe, or similar, and in some cases, this interconnect bus may be considered to be part of fabric 170.

The interconnect technology may be provided by a single interconnect or a hybrid interconnect, such as where PCIe provides on-chip communication, 1Gb or 10Gb copper Ethernet provides relatively short connections to a ToR switch 120, and optical cabling provides relatively longer connections to core switch 130. Interconnect technologies include, by way of nonlimiting example, Intel® Omni-Path™, TrueScale™, Ultra Path Interconnect (UPI) (formerly called QPI or KTI), FibreChannel, Ethernet, FibreChannel over Ethernet (FCoE), InfiniBand, PCI, PCIe, or fiber optics, to name just a few. Some of these will be more suitable for certain deployments or functions than others, and selecting an appropriate fabric for the instant application is an exercise of ordinary skill.

Note however that while high-end fabrics such as Omni-Path™ are provided herein by way of illustration, more generally, fabric 170 may be any suitable interconnect or bus for the particular application. This could, in some cases, include legacy interconnects like local area networks (LANs), token ring networks, synchronous optical networks (SONET), asynchronous transfer mode (ATM) networks, wireless networks such as Wi-Fi and Bluetooth, “plain old telephone system” (POTS) interconnects, or similar. It is also expressly anticipated that in the future, new network technologies will arise to supplement or replace some of those listed here, and any such future network topologies and technologies can be or form a part of fabric 170.

In certain embodiments, fabric 170 may provide communication services on various “layers,” as originally outlined in the OSI seven-layer network model. In contemporary practice, the OSI model is not followed strictly. In general terms, layers 1 and 2 are often called the “Ethernet” layer (though in large data centers, Ethernet has often been supplanted by newer technologies). Layers 3 and 4 are often referred to as the transmission control protocol/internet protocol (TCP/IP) layer (which may be further subdivided into TCP and IP layers). Layers 5-7 may be referred to as the “application layer.” These layer definitions are disclosed as a useful framework, but are intended to be nonlimiting.

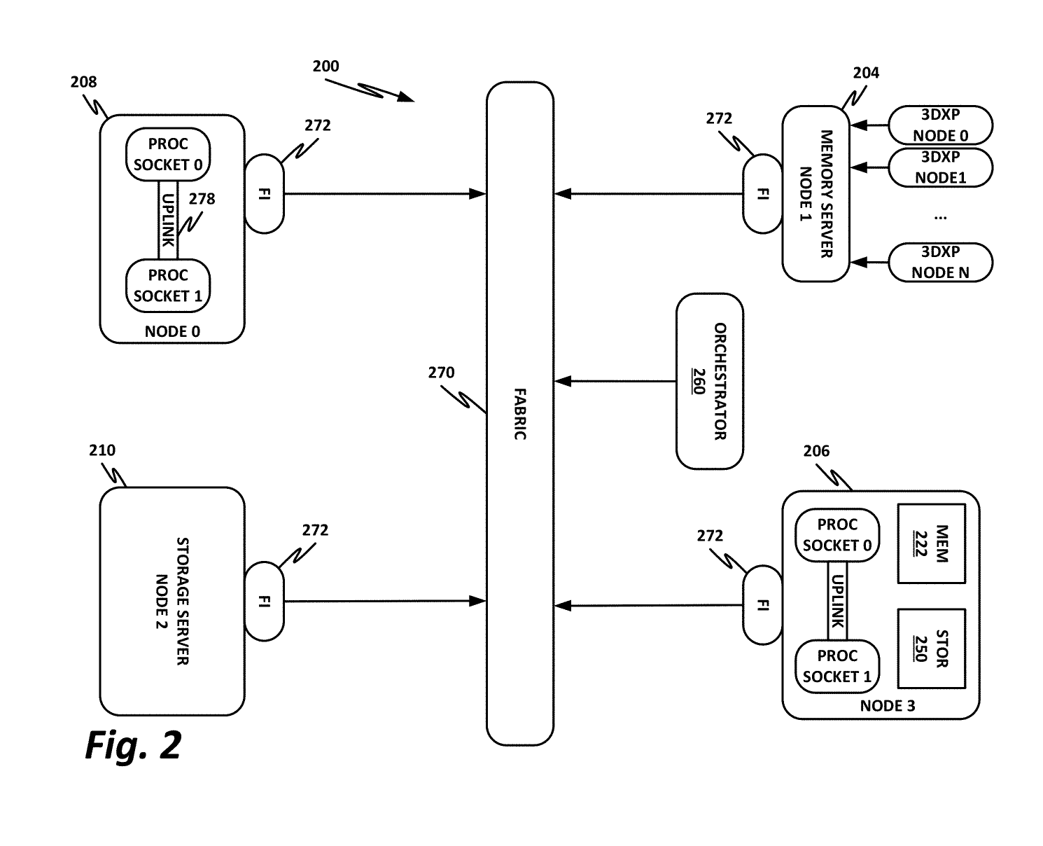

FIG. 2 is a block diagram of a data center 200 according to one or more examples of the present specification. Data center 200 may be, in various embodiments, the same as network 100 of FIG. 1, or may be a different data center. Additional views are provided in FIG. 2 to illustrate different aspects of data center 200.

In this example, a fabric 270 is provided to interconnect various aspects of data center 200. Fabric 270 may be the same as fabric 170 of FIG. 1, or may be a different fabric. As above, fabric 270 may be provided by any suitable interconnect technology. In this example, Intel® Omni-Path™ is used as an illustrative and nonlimiting example.

As illustrated, data center 200 includes a number of logic elements forming a plurality of nodes. It should be understood that each node may be provided by a physical server, a group of servers, or other hardware. Each server may be running one or more virtual machines as appropriate to its application.

Node 0 208 is a processing node including a processor socket 0 and processor socket 1. The processors may be, for example, Intel® Xeon™ processors with a plurality of cores, such as 4 or 8 cores. Node 0 208 may be configured to provide network or workload functions, such as by hosting a plurality of virtual machines or virtual appliances.

Onboard communication between processor socket 0 and processor socket 1 may be provided by an onboard uplink 278. This may provide a very high speed, short-length interconnect between the two processor sockets, so that virtual machines running on node 0 208 can communicate with one another at very high speeds. To facilitate this communication, a virtual switch (vSwitch) may be provisioned on node 0 208, which may be considered to be part of fabric 270.

Node 0 208 connects to fabric 270 via an HFI 272. HFI 272 may connect to an Intel® Omni-Path™ fabric. In some examples, communication with fabric 270 may be tunneled, such as by providing UPI tunneling over Omni-Path™.

Because data center 200 may provide many functions in a distributed fashion that in previous generations were provided onboard, a highly capable HFI 272 may be provided. HFI 272 may operate at speeds of multiple gigabits per second, and in some cases may be tightly coupled with node 0 208. For example, in some embodiments, the logic for HFI 272 is integrated directly with the processors on a system-on-a-chip. This provides very high speed communication between HFI 272 and the processor sockets, without the need for intermediary bus devices, which may introduce additional latency into the fabric. However, this is not to imply that embodiments where HFI 272 is provided over a traditional bus are to be excluded. Rather, it is expressly anticipated that in some examples, HFI 272 may be provided on a bus, such as a PCIe bus, which is a serialized version of PCI that provides higher speeds than traditional PCI. Throughout data center 200, various nodes may provide different types of HFIs 272, such as onboard HFIs and plug-in HFIs. It should also be noted that certain blocks in a system on a chip may be provided as intellectual property (IP) blocks that can be “dropped” into an integrated circuit as a modular unit. Thus, HFI 272 may in some cases be derived from such an IP block.

Note that in “the network is the device” fashion, node 0 208 may provide limited or no onboard memory or storage. Rather, node 0 208 may rely primarily on distributed services, such as a memory server and a networked storage server. Onboard, node 0 208 may provide only sufficient memory and storage to bootstrap the device and get it communicating with fabric 270. This kind of distributed architecture is possible because of the very high speeds of contemporary data centers, and may be advantageous because there is no need to over-provision resources for each node. Rather, a large pool of high-speed or specialized memory may be dynamically provisioned between a number of nodes, so that each node has access to a large pool of resources, but those resources do not sit idle when that particular node does not need them.

In this example, a node 1 memory server 204 and a node 2 storage server 210 provide the operational memory and storage capabilities of node 0 208. For example, memory server node 1 204 may provide remote direct memory access (RDMA), whereby node 0 208 may access memory resources on node 1 204 via fabric 270 in a DMA fashion, similar to how it would access its own onboard memory. The memory provided by memory server 204 may be traditional memory, such as double data rate type 3 (DDR3) dynamic random access memory (DRAM), which is volatile, or may be a more exotic type of memory, such as a persistent fast memory (PFM) like Intel® 3D Crosspoint™ (3DXP), which operates at DRAM-like speeds, but is nonvolatile.

Similarly, rather than providing an onboard hard disk for node 0 208, a storage server node 2 210 may be provided. Storage server 210 may provide a networked bunch of disks (NBOD), PFM, redundant array of independent disks (RAID), redundant array of independent nodes (RAIN), network attached storage (NAS), optical storage, tape drives, or other nonvolatile memory solutions.

Thus, in performing its designated function, node 0 208 may access memory from memory server 204 and store results on storage provided by storage server 210. Each of these devices couples to fabric 270 via a HFI 272, which provides fast communication that makes these technologies possible.

By way of further illustration, node 3 206 is also depicted. Node 3 206 also includes a HFI 272, along with two processor sockets internally connected by an uplink. However, unlike node 0 208, node 3 206 includes its own onboard memory 222 and storage 250. Thus, node 3 206 may be configured to perform its functions primarily onboard, and may not be required to rely upon memory server 204 and storage server 210. However, in appropriate circumstances, node 3 206 may supplement its own onboard memory 222 and storage 250 with distributed resources similar to node 0 208.

The basic building block of the various components disclosed herein may be referred to as “logic elements.” Logic elements may include hardware (including, for example, a software-programmable processor, an ASIC, or an FPGA), external hardware (digital, analog, or mixed-signal), software, reciprocating software, services, drivers, interfaces, components, modules, algorithms, sensors, components, firmware, microcode, programmable logic, or objects that can coordinate to achieve a logical operation. Furthermore, some logic elements are provided by a tangible, non-transitory computer-readable medium having stored thereon executable instructions for instructing a processor to perform a certain task. Such a non-transitory medium could include, for example, a hard disk, solid state memory or disk, read-only memory (ROM), persistent fast memory (PFM) (e.g., Intel® 3D Crosspoint™), external storage, redundant array of independent disks (RAID), redundant array of independent nodes (RAIN), network-attached storage (NAS), optical storage, tape drive, backup system, cloud storage, or any combination of the foregoing by way of nonlimiting example. Such a medium could also include instructions programmed into an FPGA, or encoded in hardware on an ASIC or processor.

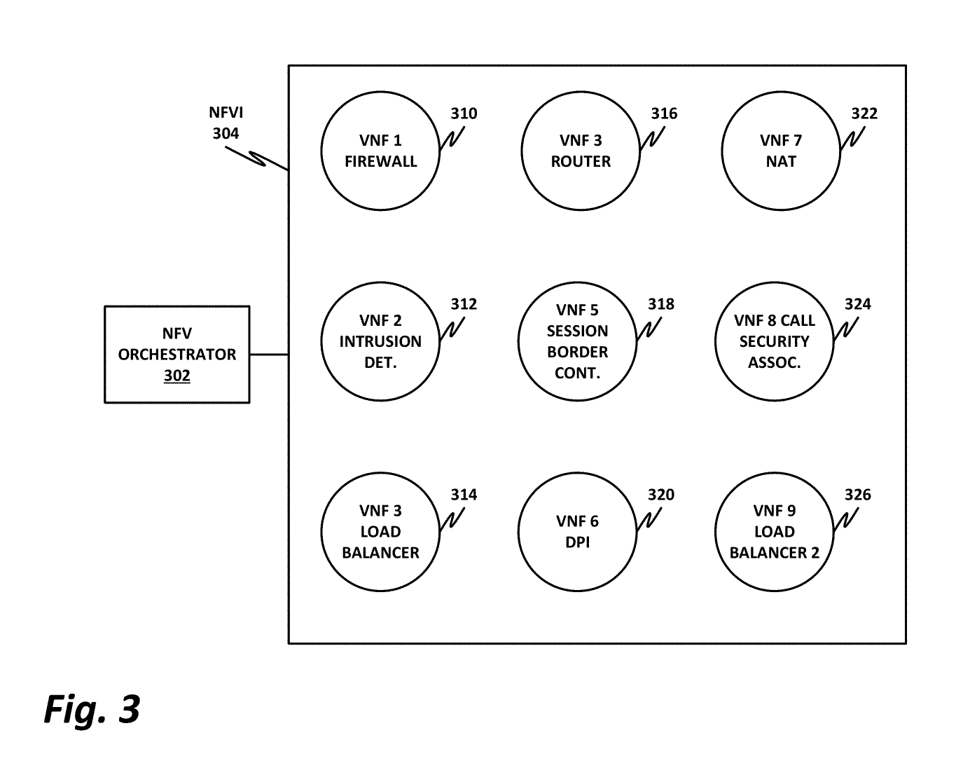

FIG. 3 is a block diagram of a network function virtualization (NFV) architecture according to one or more examples of the present specification. NFV is a second nonlimiting flavor of network virtualization, but sometimes treated as a separate entity. NFV was originally envisioned as a method for providing reduced capital expenditure (Capex) and operating expenses (Opex) for telecommunication services. One important feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, virtual network functions (VNFs) can be provisioned (“spun up”) or removed (“spun down”) to meet network demands. For example, in times of high load, more load balancer VNFs may be spun up to distribute traffic to more workload servers (which may themselves be virtual machines). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI). Often, the VNFs are inline service functions that are separate from workload servers or other nodes. These VN Fs can be chained together into a service chain, which may be defined by a virtual subnetwork, and which may include a serial string of network services that provide behind-the-scenes work, such as security, logging, billing, and similar.

In the example of FIG. 3, an NFV orchestrator (NFVO) 302 manages a number of the VNFs running on an NFVI 304. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus the need for NFV orchestrator 302.

Note that NFV orchestrator 302 itself is usually virtualized (rather than a special-purpose hardware appliance). NFV orchestrator 302 may be integrated within an existing SDN system, wherein an operations support system (OSS) manages the SDN. This may interact with virtual infrastructure management (VIM) systems (e.g., OpenStack) to provide NFV resourcing. An NFVI 304 may include the hardware, software, and other infrastructure to enable VNFs to run. This may include a rack or several racks of blade or slot servers (including, e.g., processors, memory, and storage), one or more data centers, other hardware resources distributed across one or more geographic locations, hardware switches, or network interfaces. An NFVI 304 may also include the software architecture that enables hypervisors to run and be managed by NFV orchestrator 302. Running on NFVI 304 are a number of virtual machines, each of which in this example is a VNF providing a virtual service appliance. These include, as nonlimiting and illustrative examples, VNF 1 310, which is a firewall, VNF 2 312, which is an intrusion detection system, VNF 3 314, which is a load balancer, VNF 4 316, which is a router, VNF 5 318, which is a session border controller, VNF 6 320, which is a deep packet inspection (DPI) service, VNF 7 322, which is a network address translation (NAT) module, VNF 8 324, which provides call security association, and VNF 9 326, which is a second load balancer spun up to meet increased demand.

Firewall 310 is a security appliance that monitors and controls the traffic (both incoming and outgoing), based on matching traffic to a list of “firewall rules.” Firewall 310 may be a barrier between a relatively trusted (e.g., internal) network, and a relatively untrusted network (e.g., the Internet). Once traffic has passed inspection by firewall 310, it may be forwarded to other parts of the network.

Intrusion detection 312 monitors the network for malicious activity or policy violations. Incidents may be reported to a security administrator, or collected and analyzed by a security information and event management (SIEM) system. In some cases, intrusion detection 312 may also include antivirus or antimalware scanners.

Load balancers 314 and 326 may farm traffic out to a group of substantially identical workload servers to distribute the work in a fair fashion. In one example, a load balancer provisions a number of traffic “buckets,” and assigns each bucket to a workload server. Incoming traffic is assigned to a bucket based on a factor, such as a hash of the source IP address. Because the hashes are assumed to be fairly evenly distributed, each workload server receives a reasonable amount of traffic.

Router 316 forwards packets between networks or subnetworks. For example, router 316 may include one or more ingress interfaces, and a plurality of egress interfaces, with each egress interface being associated with a resource, subnetwork, virtual private network, or other division. When traffic comes in on an ingress interface, router 316 determines what destination it should go to, and routes the packet to the appropriate egress interface.

Session border controller 318 controls voice over IP (VoIP) signaling, as well as the media streams to set up, conduct, and terminate calls. In this context, “session” refers to a communication event (e.g., a “call”). “Border” refers to a demarcation between two different parts of a network (similar to a firewall).

DPI appliance 320 provides deep packet inspection, including examining not only the header, but also the content of a packet to search for potentially unwanted content (PUC), such as protocol non-compliance, malware, viruses, spam, or intrusions.

NAT module 322 provides network address translation services to remap one IP address space into another (e.g., mapping addresses within a private subnetwork onto the larger internet).

Call security association 324 creates a security association for a call or other session (see session border controller 318 above). Maintaining this security association may be critical, as the call may be dropped if the security association is broken.

The illustration of FIG. 3 shows that a number of VNFs have been provisioned and exist within NFVI 304. This figure does not necessarily illustrate any relationship between the VNFs and the larger network.

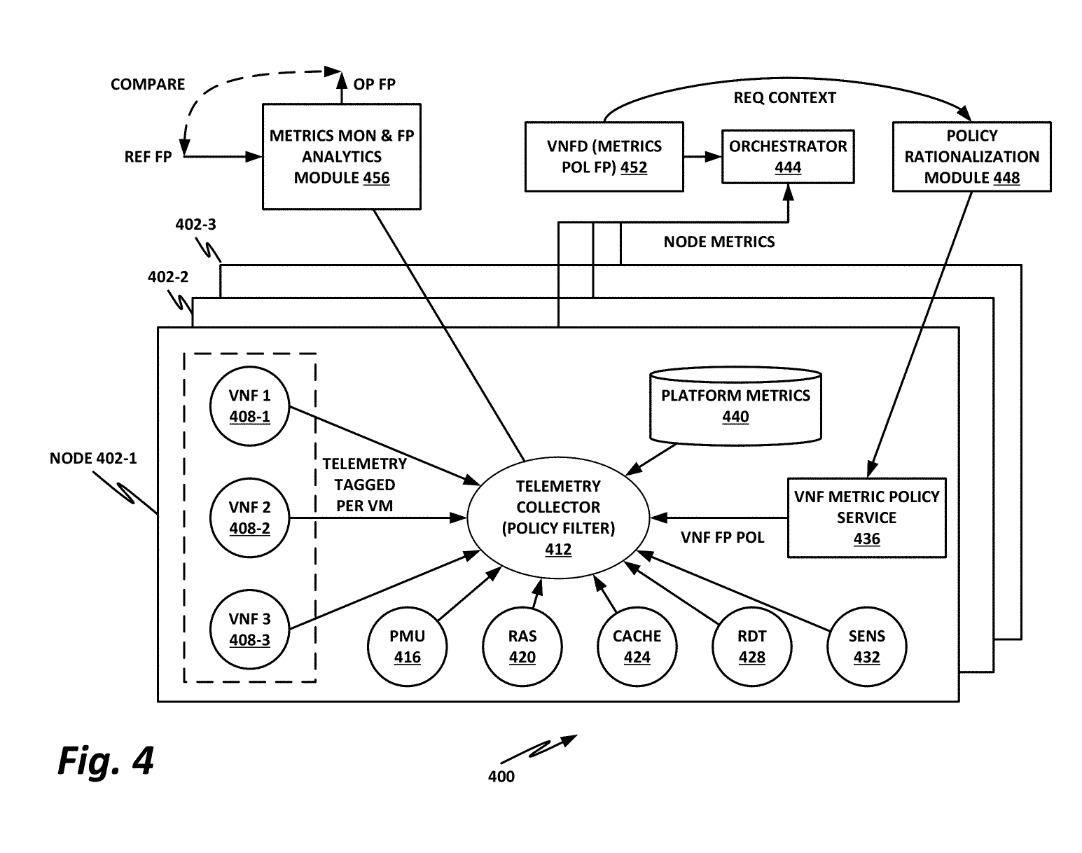

FIG. 4 is a block diagram of an example computing system 400, according to one or more examples of the present specification.

In this example, computing system 400 includes a plurality of compute nodes 402, namely in this example nodes 402-1, 402-2, and 402-3. It should be understood that a computing system such as system 400 may include only one hardware node 402, or may include many hardware nodes 402, including many more than are shown in this figure by way of illustrative example only.

An orchestrator 444 may be included to provision and manage a plurality of VNFs 408. For example, orchestrator 444 may include an infrastructure as a service (IaaS) driver, or a network stack such as OpenStack, or may be or include a virtual machine manager and/or a hypervisor.

Orchestrator 444 can instruct node 402-1 to provision a plurality of VNFs 408 according to a VNF descriptor (VNFD) 452. This descriptor defines the resources that may be required to deploy the VNF, including processing resources, memory resources, storage allocation, bandwidth, accelerators, and any other resources that may be required by VNF 408.

Certain existing VNFDs 452 do not include metrics for collection by the VNF. But according to embodiments of the present specification, a telemetry fingerprint policy description (TFPD) may also be provided within VNFD 452. This TFPD is a data structure that may contain a “recipe” to build a fingerprint policy for a VNF instance when the VNF is instantiated. In certain embodiments, provisioning of the VNF may include filtering available host platforms according to available metrics. For example, host platforms that do not have the necessary metrics to support the TFPD may not be considered as candidates on which to instantiate the VNF.

Embodiments of a TFPD may be configured to provide any suitable set of metrics, including for example metrics for measuring performance, security, and/or reliability.

At deployment time, VNFD 452 is interpreted by orchestrator 444. Orchestrator 444 may contain a subsystem called a policy rationalization module 448, which receives as an input the TFPD defined in VNFD 452, along with a required context for the fingerprinting, such as performance, security, reliability, or other. Policy rationalization module 448 may also receive as an input any available metrics for resources within the NFVI nodes.

Policy rationalization module 448 outputs a policy on a per-fingerprint basis to a VNF metric policy service 436 running on node 402-1. Note that VNF 1 408-1, VNF 2 408-2, and VNF 3 408-3 have all been provisioned on node 402-1 in this example, thus, policy rationalization module 448 will output to VNF metric policy service 436 an individual policy per virtual machine to VNF metric policy service 436.

A telemetry collector 412 may also be provided on node 402-1. Telemetry collector 412 may collect metrics from, by way of nonlimiting example, a performance monitoring unit (PMU) 416, a reliability, availability, and serviceability (RAS) block 420, a cache monitor 424, an RDT 428 (or similar hardware metrics device), and/or other sensors 432.

Collected metrics may be stored in platform metrics 440. Telemetry collector 412 may then apply to available platform metrics 440 a policy filter that is specific to each VNF 408. This selectively identifies the metrics on a per-ingredient basis, and may also include other configuration details such as frequency of collection, by way of nonlimiting example. Telemetry collector 412 may also tag the metrics data on a per-VNF basis, or in other words, each metric may be associated with a corresponding VNF 408 that is consuming or using the resource associated with that metric. Thus, hardware resources used by VNF 1 408-1 may be tagged according to VNF 1 408-1, while other hardware resources (i.e., different regions of memory, cache, storage, hardware accelerators, or other resources) that are allocated to VNF 2 408-2 may have their respective metrics tagged for VNF 2 408-2.

Data collected and tagged by telemetry collector 412 may be exposed in one example to a fingerprint analytics module (FAM) 456. FAM 456 may include a reference fingerprint, which may be provided, e.g., by the VNFD 452, and may also calculate an operational fingerprint according to the current operating metrics of a particular VNF 408. FAM 456 compares the reference fingerprint to the operational fingerprint, and may compute variation on a sliding window, or according to an instantaneous variation such as a standard deviation. Note that the fingerprint may be a composite or synthetic metric, which includes multiple factors. Thus, a small variation in a single metric may not be sufficient to raise an alert condition. However, an individual metric going out of normal range by a degree exceeding an acceptable threshold may be cause to flag an alert condition. However, the use of the fingerprint advantageously also means that if the composite fingerprint metric goes out of tolerance over time, this can also be used to flag a condition, even if all of the individual metrics are within their individual tolerance.

Advantageously, having the metrics tagged on a per-VNF basis supports the ability to implement fingerprints that can be used to identify inter-VNF effects, such as noisy neighbors. FAM 456 may compare the current fingerprint for a given context of interest against a reference fingerprint for that context.

In the case that FAM 456 detects a difference in the fingerprint exceeding a threshold, which may be an instantaneous threshold, or which may include a sliding window in which it exceeds a certain variance over time, an actuation action trigger may be sent to orchestrator 444 with appropriate metadata to enable orchestrator 444 to adjust the behavior of the VNF 408. This could include, for example, provisioning additional instances of VNF 408 or allocating additional resources or capability (e.g., memory, storage, processors, or network bandwidth) in the case that performance metrics are not being met, reducing capability (e.g., de-allocating instances of the VNF, or reducing the allocation of memory, storage, processors, or network bandwidth) in the case of over-provisioning, taking action to increase performance of the VNF (e.g., elevating or reducing a Quality of Service (QoS) or service level agreement (SLA) metric), taking a security action (e.g., allocating firewall rules or flow rules, detecting a DoS attack, or similar) in the case of a security event, correcting hardware or software failures, or taking other corrective action.

For example, the fingerprint could be used to detect events such as abnormal behavior stemming from a deliberate denial of service attack or a malware infection. In this example, orchestrator 444 could also take appropriate action such as configuring a desirable firewall rule, running an antivirus scanner, placing the affected VNF 408 into a sandbox or other safe environment, or running an antivirus service, by way of nonlimiting example.

Note that in some embodiments, the actuation trigger may trigger an increase in the rate of fingerprinting for a certain period to ensure that orchestrator 444 has successfully mitigated the issue.

This provides a very efficient and targeted method of collecting platform metrics to identify issues affecting the services. By using a fingerprinting approach (in addition to or instead of an individual metric approach), broader system-level or systemic issues may be identified, as opposed to using atomic metrics which may identify only individual events, or which may trigger false positives because of simple hysteresis in the signal. Furthermore, the ability to expose and exploit fine-grained metric collection (i.e., CPU, chipset, NIC, SSD, or other) has the potential to act as a platform differentiator and a source of new infrastructure insights.

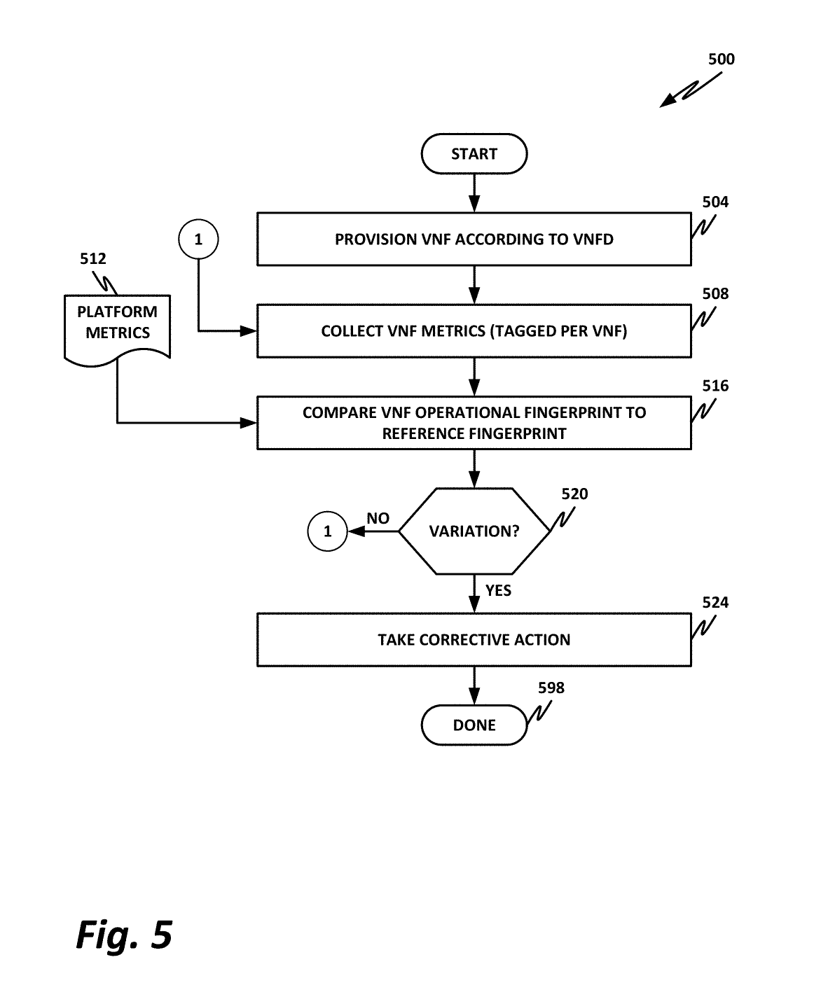

FIG. 5 is a flowchart of a method 500 performed according to embodiments of the present specification. Note that the method 500 of FIG. 5 is provided as an illustration only, and that the operations performed in method 500 may be performed as appropriate by any of the devices illustrated in connection with FIG. 4, or by any other appropriate device.

In block 504, a new VNF instance is provisioned on a hardware platform according to a VNFD, as illustrated in the preceding examples. Note that in some embodiments, provisioning may include applying a filter, such as querying a number of host platforms for telemetry capabilities, and filtering out host platforms that do not provide the minimum telemetry capabilities for the TFPD.

In block 508, VNF-specific metrics are collected for the newly provisioned VNF, including any metrics specified in a VNFD that was used to spawn the VNF.

In block 516, available platform metrics 512 are received and filtered to prepare an operational fingerprint for the current instance of the VNF. The operational fingerprint may be compared to a reference fingerprint specified, for example, in the VNFD, and any difference may be calculated. This can include a one-time comparison, or may include comparison over a sliding window or other time period. In some embodiments, frequency domain computations may also be used.

In decision block 520, a determination is made whether there is a variation in the operational fingerprint from the reference fingerprint. This can include determining whether there is a variation that exceeds a particular threshold, or that may be computed over a time window.

If there is no variation, then control returns to block 508, and metrics can for example be continuously collected as long as the VNF continues to run, or on some other useful schedule.

Returning to block 520, if there is a variation between the operational fingerprint and the reference fingerprint, then in block 524, appropriate corrective action may be taken. Such corrective action may be, for example, any of those corrective actions discussed above.

In block 598, the method is done.

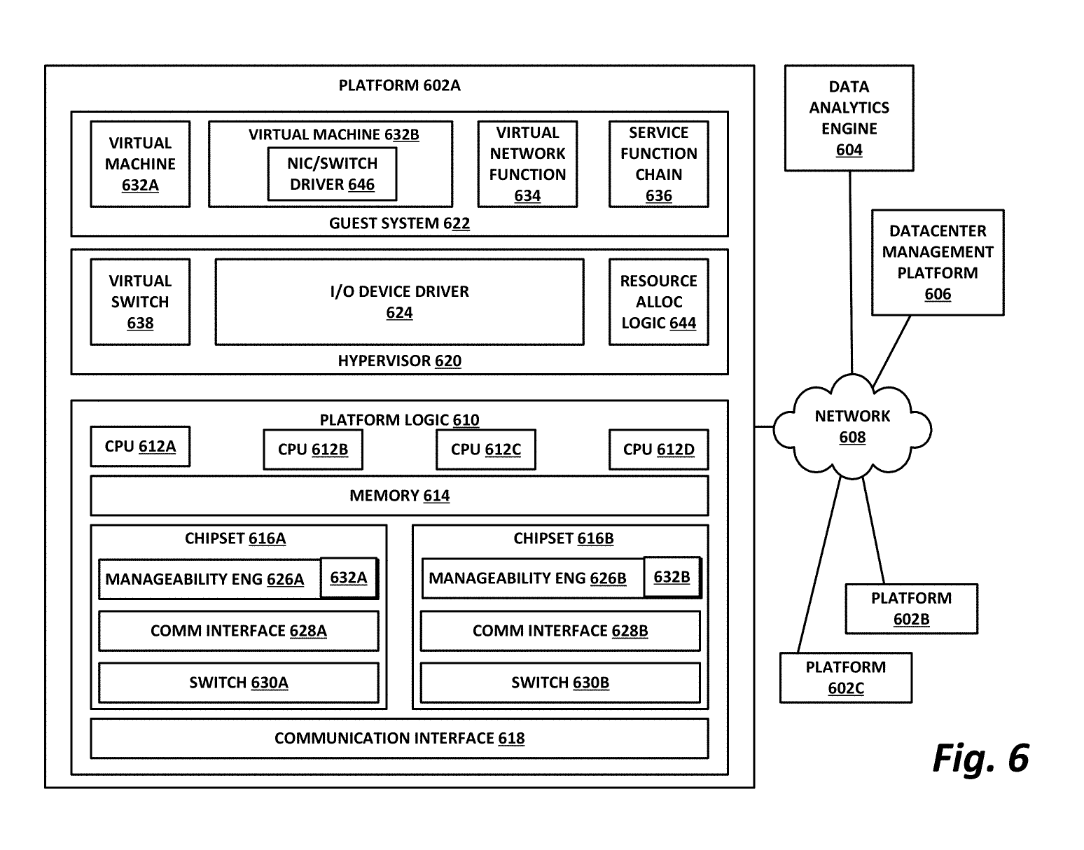

FIG. 6 is a block diagram of components of a computing platform 602A according to one or more examples of the present specification. In the embodiment depicted, platforms 602A, 602B, and 602C, along with a data center management platform 606 and data analytics engine 604 are interconnected via network 608. In other embodiments, a computer system may include any suitable number of (i.e., one or more) platforms. In some embodiments (e.g., when a computer system only includes a single platform), all or a portion of the system management platform 606 may be included on a platform 602. A platform 602 may include platform logic 610 with one or more central processing units (CPUs) 612, memories 614 (which may include any number of different modules), chipsets 616, communication interfaces 618, and any other suitable hardware and/or software to execute a hypervisor 620 or other operating system capable of executing workloads associated with applications running on platform 602. In some embodiments, a platform 602 may function as a host platform for one or more guest systems 622 that invoke these applications. Platform 602A may represent any suitable computing environment, such as a high performance computing environment, a data center, a communications service provider infrastructure (e.g., one or more portions of an Evolved Packet Core), an in-memory computing environment, a computing system of a vehicle (e.g., an automobile or airplane), an Internet of Things environment, an industrial control system, other computing environment, or combination thereof.

In various embodiments of the present disclosure, accumulated stress and/or rates of stress accumulated of a plurality of hardware resources (e.g., cores and uncores) are monitored and entities (e.g., system management platform 606, hypervisor 620, or other operating system) of computer platform 602A may assign hardware resources of platform logic 610 to perform workloads in accordance with the stress information. In some embodiments, self-diagnostic capabilities may be combined with the stress monitoring to more accurately determine the health of the hardware resources. Each platform 602 may include platform logic 610. Platform logic 610 comprises, among other logic enabling the functionality of platform 602, one or more CPUs 612, memory 614, one or more chipsets 616, and communication interfaces 628. Although three platforms are illustrated, computer platform 602A may be interconnected with any suitable number of platforms. In various embodiments, a platform 602 may reside on a circuit board that is installed in a chassis, rack, or other suitable structure that comprises multiple platforms coupled together through network 608 (which may comprise, e.g., a rack or backplane switch).

CPUs 612 may each comprise any suitable number of processor cores and supporting logic (e.g., uncores). The cores may be coupled to each other, to memory 614, to at least one chipset 616, and/or to a communication interface 618, through one or more controllers residing on CPU 612 and/or chipset 616. In particular embodiments, a CPU 612 is embodied within a socket that is permanently or removably coupled to platform 602A. Although four CPUs are shown, a platform 602 may include any suitable number of CPUs.

Memory 614 may comprise any form of volatile or nonvolatile memory including, without limitation, magnetic media (e.g., one or more tape drives), optical media, random access memory (RAM), read-only memory (ROM), flash memory, removable media, or any other suitable local or remote memory component or components. Memory 614 may be used for short, medium, and/or long term storage by platform 602A. Memory 614 may store any suitable data or information utilized by platform logic 610, including software embedded in a computer readable medium, and/or encoded logic incorporated in hardware or otherwise stored (e.g., firmware). Memory 614 may store data that is used by cores of CPUs 612. In some embodiments, memory 614 may also comprise storage for instructions that may be executed by the cores of CPUs 612 or other processing elements (e.g., logic resident on chipsets 616) to provide functionality associated with the manageability engine 626 or other components of platform logic 610. A platform 602 may also include one or more chipsets 616 comprising any suitable logic to support the operation of the CPUs 612. In various embodiments, chipset 616 may reside on the same die or package as a CPU 612 or on one or more different dies or packages. Each chipset may support any suitable number of CPUs 612. A chipset 616 may also include one or more controllers to couple other components of platform logic 610 (e.g., communication interface 618 or memory 614) to one or more CPUs. In the embodiment depicted, each chipset 616 also includes a manageability engine 626. Manageability engine 626 may include any suitable logic to support the operation of chipset 616. In a particular embodiment, a manageability engine 626 (which may also be referred to as an innovation engine) is capable of collecting real-time telemetry data from the chipset 616, the CPU(s) 612 and/or memory 614 managed by the chipset 616, other components of platform logic 610, and/or various connections between components of platform logic 610. In various embodiments, the telemetry data collected includes the stress information described herein.

In various embodiments, a manageability engine 626 operates as an out-of-band asynchronous compute agent which is capable of interfacing with the various elements of platform logic 610 to collect telemetry data with no or minimal disruption to running processes on CPUs 612. For example, manageability engine 626 may comprise a dedicated processing element (e.g., a processor, controller, or other logic) on chipset 616, which provides the functionality of manageability engine 626 (e.g., by executing software instructions), thus conserving processing cycles of CPUs 612 for operations associated with the workloads performed by the platform logic 610. Moreover the dedicated logic for the manageability engine 626 may operate asynchronously with respect to the CPUs 612 and may gather at least some of the telemetry data without increasing the load on the CPUs.

A manageability engine 626 may process telemetry data it collects (specific examples of the processing of stress information will be provided herein). In various embodiments, manageability engine 626 reports the data it collects and/or the results of its processing to other elements in the computer system, such as one or more hypervisors 620 or other operating systems and/or system management software (which may run on any suitable logic such as system management platform 606). In particular embodiments, a critical event such as a core that has accumulated an excessive amount of stress may be reported prior to the normal interval for reporting telemetry data (e.g., a notification may be sent immediately upon detection).

Additionally, manageability engine 626 may include programmable code configurable to set which CPU(s) 612 a particular chipset 616 will manage and/or which telemetry data will be collected.

Chipsets 616 also each include a communication interface 628. Communication interface 628 may be used for the communication of signaling and/or data between chipset 616 and one or more I/O devices, one or more networks 608, and/or one or more devices coupled to network 608 (e.g., system management platform 606). For example, communication interface 628 may be used to send and receive network traffic such as data packets. In a particular embodiment, a communication interface 628 comprises one or more physical network interface controllers (NICs), also known as network interface cards or network adapters. A NIC may include electronic circuitry to communicate using any suitable physical layer and data link layer standard such as Ethernet (e.g., as defined by a IEEE 802.3 standard), Fibre Channel, InfiniBand, Wi-Fi, or other suitable standard. A NIC may include one or more physical ports that may couple to a cable (e.g., an Ethernet cable). A NIC may enable communication between any suitable element of chipset 616 (e.g., manageability engine 626 or switch 630) and another device coupled to network 608. In various embodiments a NIC may be integrated with the chipset (i.e., may be on the same integrated circuit or circuit board as the rest of the chipset logic) or may be on a different integrated circuit or circuit board that is electromechanically coupled to the chipset.

In particular embodiments, communication interfaces 628 may allow communication of data (e.g., between the manageability engine 626 and the data center management platform 606) associated with management and monitoring functions performed by manageability engine 626. In various embodiments, manageability engine 626 may utilize elements (e.g., one or more NICs) of communication interfaces 628 to report the telemetry data (e.g., to system management platform 606) in order to reserve usage of NICs of communication interface 618 for operations associated with workloads performed by platform logic 610.

Switches 630 may couple to various ports (e.g., provided by NICs) of communication interface 628 and may switch data between these ports and various components of chipset 616 (e.g., one or more Peripheral Component Interconnect Express (PCIe) lanes coupled to CPUs 612). Switches 630 may be a physical or virtual (i.e., software) switch.

Platform logic 610 may include an additional communication interface 618. Similar to communication interfaces 628, communication interfaces 618 may be used for the communication of signaling and/or data between platform logic 610 and one or more networks 608 and one or more devices coupled to the network 608. For example, communication interface 618 may be used to send and receive network traffic such as data packets. In a particular embodiment, communication interfaces 618 comprise one or more physical NICs. These NICs may enable communication between any suitable element of platform logic 610 (e.g., CPUs 512 or memory 514) and another device coupled to network 608 (e.g., elements of other platforms or remote computing devices coupled to network 608 through one or more networks).

Platform logic 610 may receive and perform any suitable types of workloads. A workload may include any request to utilize one or more resources of platform logic 610, such as one or more cores or associated logic. For example, a workload may comprise a request to instantiate a software component, such as an I/O device driver 624 or guest system 622; a request to process a network packet received from a virtual machine 632 or device external to platform 602A (such as a network node coupled to network 608); a request to execute a process or thread associated with a guest system 622, an application running on platform 602A, a hypervisor 620 or other operating system running on platform 602A; or other suitable processing request.

A virtual machine 632 may emulate a computer system with its own dedicated hardware. A virtual machine 632 may run a guest operating system on top of the hypervisor 620. The components of platform logic 610 (e.g., CPUs 612, memory 614, chipset 616, and communication interface 618) may be virtualized such that it appears to the guest operating system that the virtual machine 632 has its own dedicated components.

A virtual machine 632 may include a virtualized NIC (vNIC), which is used by the virtual machine as its network interface. A vNIC may be assigned a media access control (MAC) address or other identifier, thus allowing multiple virtual machines 632 to be individually addressable in a network.

VNF 634 may comprise a software implementation of a functional building block with defined interfaces and behavior that can be deployed in a virtualized infrastructure. In particular embodiments, a VNF 634 may include one or more virtual machines 632 that collectively provide specific functionalities (e.g., wide area network (WAN) optimization, virtual private network (VPN) termination, firewall operations, load-balancing operations, security functions, etc.). A VNF 634 running on platform logic 610 may provide the same functionality as traditional network components implemented through dedicated hardware. For example, a VNF 634 may include components to perform any suitable NFV workloads, such as virtualized evolved packet core (vEPC) components, mobility management entities, 3rd Generation Partnership Project (3GPP) control and data plane components, etc.

SFC 636 is a group of VNFs 634 organized as a chain to perform a series of operations, such as network packet processing operations. Service function chaining may provide the ability to define an ordered list of network services (e.g. firewalls, load balancers) that are stitched together in the network to create a service chain.

A hypervisor 620 (also known as a virtual machine monitor) may comprise logic to create and run guest systems 622. The hypervisor 620 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 610. Services of hypervisor 620 may be provided by virtualizing in software or through hardware assisted resources that require minimal software intervention, or both. Multiple instances of a variety of guest operating systems may be managed by the hypervisor 620. Each platform 602 may have a separate instantiation of a hypervisor 620.

Hypervisor 620 may be a native or bare-metal hypervisor that runs directly on platform logic 610 to control the platform logic and manage the guest operating systems. Alternatively, hypervisor 620 may be a hosted hypervisor that runs on a host operating system and abstracts the guest operating systems from the host operating system. Hypervisor 620 may include a virtual switch 638 that may provide virtual switching and/or routing functions to virtual machines of guest systems 622. The virtual switch 638 may comprise a logical switching fabric that couples the vNICs of the virtual machines 632 to each other, thus creating a virtual network through which virtual machines may communicate with each other.

Virtual switch 638 may comprise a software element that is executed using components of platform logic 610. In various embodiments, hypervisor 620 may be in communication with any suitable entity (e.g., a SDN controller) which may cause hypervisor 620 to reconfigure the parameters of virtual switch 638 in response to changing conditions in platform 602 (e.g., the addition or deletion of virtual machines 632 or identification of optimizations that may be made to enhance performance of the platform).

Hypervisor 620 may also include resource allocation logic 644, which may include logic for determining allocation of platform resources based on the telemetry data (which may include stress information). Resource allocation logic 644 may also include logic for communicating with various components of platform logic 610 entities of platform 602A to implement such optimization, such as components of platform logic 610.

Any suitable logic may make one or more of these optimization decisions. For example, system management platform 606; resource allocation logic 644 of hypervisor 620 or other operating system; or other logic of computer platform 602A may be capable of making such decisions. In various embodiments, the system management platform 606 may receive telemetry data from and manage workload placement across multiple platforms 602. The system management platform 606 may communicate with hypervisors 620 (e.g., in an out-of-band manner) or other operating systems of the various platforms 602 to implement workload placements directed by the system management platform.

The elements of platform logic 610 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, or a Gunning transceiver logic (GTL) bus.

Elements of the computer platform 602A may be coupled together in any suitable manner such as through one or more networks 608. A network 608 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices.

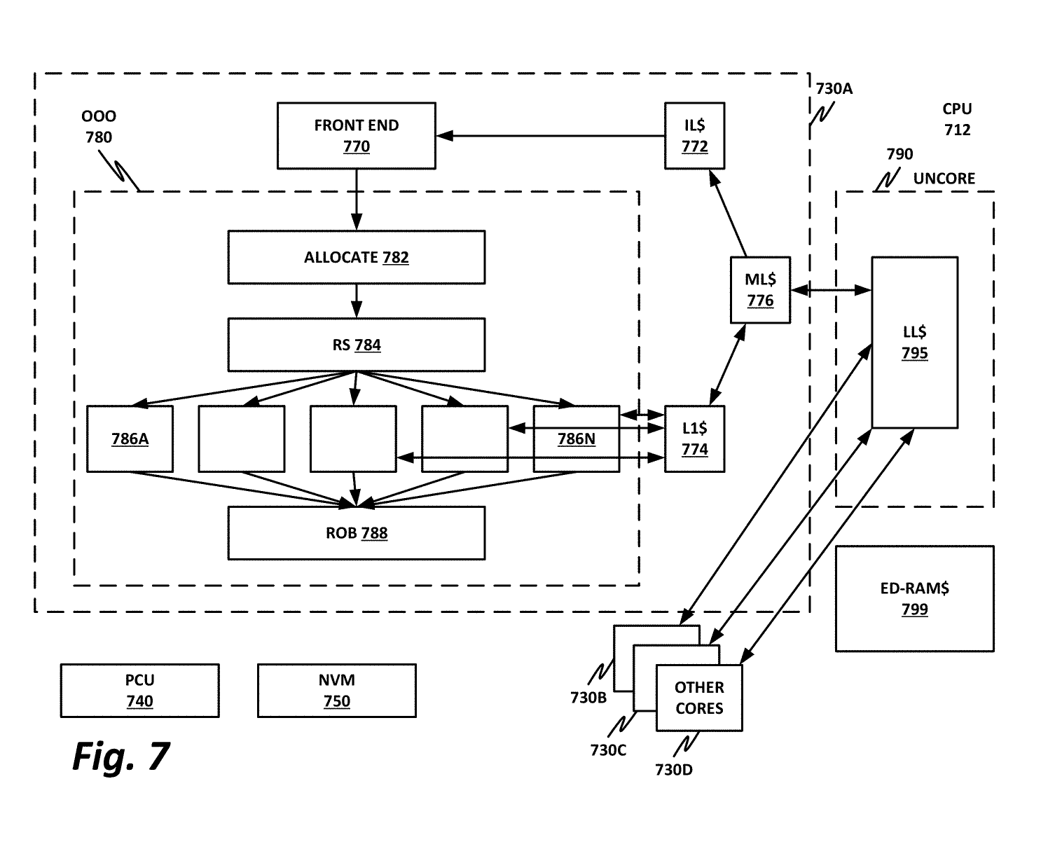

FIG. 7 illustrates a block diagram of a central processing unit (CPU) 712 in accordance with certain embodiments. Although CPU 712 depicts a particular configuration, the cores and other components of CPU 712 may be arranged in any suitable manner. CPU 712 may comprise any processor or processing device, such as a microprocessor, an embedded processor, a digital signal processor (DSP), a network processor, an application processor, a co-processor, a system on a chip (SOC), or other device to execute code. CPU 712, in the depicted embodiment, includes four processing elements (cores 730 in the depicted embodiment), which may include asymmetric processing elements or symmetric processing elements. However, CPU 712 may include any number of processing elements that may be symmetric or asymmetric.

Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. A physical CPU may include any suitable number of cores. In various embodiments, cores may include one or more out-of-order processor cores or one or more in-order processor cores. However, cores may be individually selected from any type of core, such as a native core, a software managed core, a core adapted to execute a native instruction set architecture (ISA), a core adapted to execute a translated ISA, a co-designed core, or other known core. In a heterogeneous core environment (i.e. asymmetric cores), some form of translation, such as binary translation, may be utilized to schedule or execute code on one or both cores.

In the embodiment depicted, core 730A includes an out-of-order processor that has a front end unit 770 used to fetch incoming instructions, perform various processing (e.g. caching, decoding, branch predicting, etc.) and passing instructions/operations along to an out-of-order (OOO) engine. The OOO engine performs further processing on decoded instructions.

A front end 770 may include a decode module coupled to fetch logic to decode fetched elements. Fetch logic, in one embodiment, includes individual sequencers associated with thread slots of cores 730. Usually a core 730 is associated with a first ISA, which defines/specifies instructions executable on core 730. Often machine code instructions that are part of the first ISA include a portion of the instruction (referred to as an opcode), which references/specifies an instruction or operation to be performed. The decode module may include circuitry that recognizes these instructions from their opcodes and passes the decoded instructions on in the pipeline for processing as defined by the first ISA. Decoders of cores 730, in one embodiment, recognize the same ISA (or a subset thereof). Alternatively, in a heterogeneous core environment, a decoder of one or more cores (e.g., core 730B) may recognize a second ISA (either a subset of the first ISA or a distinct ISA).

In the embodiment depicted, the out-of-order engine includes an allocate unit 782 to receive decoded instructions, which may be in the form of one or more micro-instructions or uops, from front end unit 770, and allocate them to appropriate resources such as registers and so forth. Next, the instructions are provided to a reservation station 784, which reserves resources and schedules them for execution on one of a plurality of execution units 786A-786N. Various types of execution units may be present, including, for example, arithmetic logic units (ALUs), load and store units, vector processing units (VPUs), floating point execution units, among others. Results from these different execution units are provided to a reorder buffer (ROB) 788, which take unordered results and return them to correct program order.

In the embodiment depicted, both front end unit 770 and out-of-order engine 780 are coupled to different levels of a memory hierarchy. Specifically shown is an instruction level cache 772, that in turn couples to a mid-level cache 776, that in turn couples to a last level cache 795. In one embodiment, last level cache 795 is implemented in an on-chip (sometimes referred to as uncore) unit 790. Uncore 790 may communicate with system memory 799, which, in the illustrated embodiment, is implemented via embedded DRAM (eDRAM). The various execution units 686 within 000 engine 780 are in communication with a first level cache 774 that also is in communication with mid-level cache 776. Additional cores 730B-730D may couple to last level cache 795 as well.

In particular embodiments, uncore 790 may be in a voltage domain and/or a frequency domain that is separate from voltage domains and/or frequency domains of the cores. That is, uncore 790 may be powered by a supply voltage that is different from the supply voltages used to power the cores and/or may operate at a frequency that is different from the operating frequencies of the cores.

CPU 712 may also include a power control unit (PCU) 740. In various embodiments, PCU 740 may control the supply voltages and the operating frequencies applied to each of the cores (on a per-core basis) and to the uncore. PCU 740 may also instruct a core or uncore to enter an idle state (where no voltage and clock are supplied) when not performing a workload.

In various embodiments, PCU 740 may detect one or more stress characteristics of a hardware resource, such as the cores and the uncore. A stress characteristic may comprise an indication of an amount of stress that is being placed on the hardware resource. As examples, a stress characteristic may be a voltage or frequency applied to the hardware resource; a power level, current level, or voltage level sensed at the hardware resource; a temperature sensed at the hardware resource; or other suitable measurement. In various embodiments, multiple measurements (e.g., at different locations) of a particular stress characteristic may be performed when sensing the stress characteristic at a particular instance of time. In various embodiments, PCU 740 may detect stress characteristics at any suitable interval.

In various embodiments, PCU 740 is a component that is discrete from the cores 730. In particular embodiments, PCU 740 runs at a clock frequency that is different from the clock frequencies used by cores 630. In some embodiments where the PCU is a microcontroller, PCU 740 executes instructions according to an ISA that is different from an ISA used by cores 730.

In various embodiments, CPU 712 may also include a nonvolatile memory 750 to store stress information (such as stress characteristics, incremental stress values, accumulated stress values, stress accumulation rates, or other stress information) associated with cores 730 or uncore 790, such that when power is lost, the stress information is maintained.

The foregoing outlines features of one or more embodiments of the subject matter disclosed herein. These embodiments are provided to enable a person having ordinary skill in the art (PHOSITA) to better understand various aspects of the present disclosure. Certain well-understood terms, as well as underlying technologies and/or standards may be referenced without being described in detail. It is anticipated that the PHOSITA will possess or have access to background knowledge or information in those technologies and standards sufficient to practice the teachings of the present specification.

The PHOSITA will appreciate that they may readily use the present disclosure as a basis for designing or modifying other processes, structures, or variations for carrying out the same purposes and/or achieving the same advantages of the embodiments introduced herein. The PHOSITA will also recognize that such equivalent constructions do not depart from the spirit and scope of the present disclosure, and that they may make various changes, substitutions, and alterations herein without departing from the spirit and scope of the present disclosure.

In the foregoing description, certain aspects of some or all embodiments are described in greater detail than is strictly necessary for practicing the appended claims. These details are provided by way of non-limiting example only, for the purpose of providing context and illustration of the disclosed embodiments. Such details should not be understood to be required, and should not be “read into” the claims as limitations. The phrase may refer to “an embodiment” or “embodiments.” These phrases, and any other references to embodiments, should be understood broadly to refer to any combination of one or more embodiments. Furthermore, the several features disclosed in a particular “embodiment” could just as well be spread across multiple embodiments. For example, if features 1 and 2 are disclosed in “an embodiment,” embodiment A may have feature 1 but lack feature 2, while embodiment B may have feature 2 but lack feature 1.

This specification may provide illustrations in a block diagram format, wherein certain features are disclosed in separate blocks. These should be understood broadly to disclose how various features interoperate, but are not intended to imply that those features must necessarily be embodied in separate hardware or software. Furthermore, where a single block discloses more than one feature in the same block, those features need not necessarily be embodied in the same hardware and/or software. For example, a computer “memory” could in some circumstances be distributed or mapped between multiple levels of cache or local memory, main memory, battery-backed volatile memory, and various forms of persistent memory such as a hard disk, storage server, optical disk, tape drive, or similar. In certain embodiments, some of the components may be omitted or consolidated. In a general sense, the arrangements depicted in the figures may be more logical in their representations, whereas a physical architecture may include various permutations, combinations, and/or hybrids of these elements. Countless possible design configurations can be used to achieve the operational objectives outlined herein. Accordingly, the associated infrastructure has a myriad of substitute arrangements, design choices, device possibilities, hardware configurations, software implementations, and equipment options.

References may be made herein to a computer-readable medium, which may be a tangible and non-transitory computer-readable medium. As used in this specification and throughout the claims, a “computer-readable medium” should be understood to include one or more computer-readable mediums of the same or different types. A computer-readable medium may include, by way of non-limiting example, an optical drive (e.g., CD/DVD/Blu-Ray), a hard drive, a solid-state drive, a flash memory, or other non-volatile medium. A computer-readable medium could also include a medium such as a read-only memory (ROM), an FPGA or ASIC configured to carry out the desired instructions, stored instructions for programming an FPGA or ASIC to carry out the desired instructions, an intellectual property (IP) block that can be integrated in hardware into other circuits, or instructions encoded directly into hardware or microcode on a processor such as a microprocessor, digital signal processor (DSP), microcontroller, or in any other suitable component, device, element, or object where appropriate and based on particular needs. A nontransitory storage medium herein is expressly intended to include any nontransitory special-purpose or programmable hardware configured to provide the disclosed operations, or to cause a processor to perform the disclosed operations.

Various elements may be “communicatively,” “electrically,” “mechanically,” or otherwise “coupled” to one another throughout this specification and the claims. Such coupling may be a direct, point-to-point coupling, or may include intermediary devices. For example, two devices may be communicatively coupled to one another via a controller that facilitates the communication. Devices may be electrically coupled to one another via intermediary devices such as signal boosters, voltage dividers, or buffers. Mechanically-coupled devices may be indirectly mechanically coupled.

Any “module” or “engine” disclosed herein may refer to or include software, a software stack, a combination of hardware, firmware, and/or software, a circuit configured to carry out the function of the engine or module, or any computer-readable medium as disclosed above. Such modules or engines may, in appropriate circumstances, be provided on or in conjunction with a hardware platform, which may include hardware compute resources such as a processor, memory, storage, interconnects, networks and network interfaces, accelerators, or other suitable hardware. Such a hardware platform may be provided as a single monolithic device (e.g., in a PC form factor), or with some or part of the function being distributed (e.g., a “composite node” in a high-end data center, where compute, memory, storage, and other resources may be dynamically allocated and need not be local to one another).

There may be disclosed herein flow charts, signal flow diagram, or other illustrations showing operations being performed in a particular order. Unless otherwise expressly noted, or unless required in a particular context, the order should be understood to be a non-limiting example only. Furthermore, in cases where one operation is shown to follow another, other intervening operations may also occur, which may be related or unrelated. Some operations may also be performed simultaneously or in parallel. In cases where an operation is said to be “based on” or “according to” another item or operation, this should be understood to imply that the operation is based at least partly on or according at least partly to the other item or operation. This should not be construed to imply that the operation is based solely or exclusively on, or solely or exclusively according to the item or operation.

All or part of any hardware element disclosed herein may readily be provided in a system-on-a-chip (SoC), including a central processing unit (CPU) package. An SoC represents an integrated circuit (IC) that integrates components of a computer or other electronic system into a single chip. Thus, for example, client devices or server devices may be provided, in whole or in part, in an SoC. The SoC may contain digital, analog, mixed-signal, and radio frequency functions, all of which may be provided on a single chip substrate. Other embodiments may include a multichip module (MCM), with a plurality of chips located within a single electronic package and configured to interact closely with each other through the electronic package.

In a general sense, any suitably-configured circuit or processor can execute any type of instructions associated with the data to achieve the operations detailed herein. Any processor disclosed herein could transform an element or an article (for example, data) from one state or thing to another state or thing. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein, should be construed as being encompassed within the broad terms “memory” and “storage,” as appropriate.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. Any suitable processor and memory can be suitably coupled to the board based on particular configuration needs, processing demands, and computing designs. Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

### EXAMPLE IMPLEMENTATIONS

The following examples are provided by way of illustration.

Example 1 includes a data center orchestrator, comprising: a hardware platform; a host fabric interface to communicatively couple the orchestrator to a network; an orchestrator engine to provide a data center orchestration function; and a data structure, comprising a network function virtualization definition (NFVD) instance, the NFVD instance comprising a definition for instantiating a virtual network function (VNF) on a host platform, including a telemetry fingerprint policy description (TFPD) for the VNF, wherein the TFPD comprises information to collect telemetry data selected from a set of available telemetry data for the host platform.

Example 2 includes the data center orchestrator of example 1, wherein the TFPD comprises a plurality of context-specific fingerprints.

Example 3 includes the data center orchestrator of example 2, wherein the context is selected from a group consisting of performance, security, and reliability.

Example 4 includes the data center orchestrator of example 1, further comprising a policy rationalization module to: provision a VNF instance according to the VNFD; and apply the TFPD to build a fingerprint policy for the VNF instance.

Example 5 includes the data center orchestrator of example 4, wherein building the VNF policy comprises receiving from the host platform a list of available metrics for the hardware platform.

Example 6 includes the data center orchestrator of example 5, wherein provisioning the VNF instance comprises querying a plurality of host platforms, and filtering out host platforms that will not provide telemetry required by the TFPD.

Example 7 includes the data center orchestrator of any of examples 1-6, further comprising a fingerprint analytics module to receive telemetry from the VNF instance, compare the telemetry to a reference fingerprint, and to act on the comparing.

Example 8 includes the data center orchestrator of example 7, wherein acting on the comparing comprises taking a security action.

Example 9 includes the data center orchestrator of example 7, wherein acting on the comparing comprises taking a reliability action.

Example 10 includes the data center orchestrator of example 7, wherein acting on the comparing comprises taking a performance action.

Example 11 includes the data center orchestrator of example 10, wherein the performance action comprises allocating additional capability.

Example 12 includes the data center orchestrator of example 10, wherein the performance action comprises reducing capability.

Example 13 includes one or more tangible, non-transitory computer-readable storage mediums having stored thereon instructions to cause a hardware platform to: communicatively couple a network; provide a data center orchestration function; and allocate a data structure, comprising a network function virtualization definition (NFVD) instance, the NFVD instance comprising a definition for instantiating a virtual network function (VNF) on a host platform, including a telemetry fingerprint policy description (TFPD) for the VNF, wherein the TFPD comprises information to collect telemetry data selected from a set of available telemetry data for the host platform.

Example 14 includes the one or more tangible, non-transitory computer-readable mediums of example 13, wherein the TFPD comprises a plurality of context-specific fingerprints.

Example 15 includes the one or more tangible, non-transitory computer-readable mediums of example 14, wherein the context is selected from a group consisting of performance, security, and reliability.

Example 16 includes the one or more tangible, non-transitory computer-readable mediums of example 13, wherein the instructions are further to cause the hardware platform to: provision a VNF instance according to the VNFD; and apply the TFPD to build a fingerprint policy for the VNF instance.

Example 17 includes the one or more tangible, non-transitory computer-readable mediums of example 16, wherein building the VNF policy comprises receiving from the host platform a list of available metrics for the hardware platform.

Example 18 includes the one or more tangible, non-transitory computer-readable mediums of example 17, wherein provisioning the VNF instance comprises querying a plurality of host platforms, and filtering out host platforms that will not provide telemetry required by the TFPD.

Example 19 includes the one or more tangible, non-transitory computer-readable mediums of any of examples 13-18, wherein the instructions are further to cause the hardware platform to receive telemetry from the VNF instance, compare the telemetry to a reference fingerprint, and to act on the comparing.

Example 20 includes the one or more tangible, non-transitory computer-readable mediums of example 19, wherein acting on the comparing comprises taking a security action.

Example 21 includes the one or more tangible, non-transitory computer-readable mediums of example 19, wherein acting on the comparing comprises taking a reliability action.

Example 22 includes the one or more tangible, non-transitory computer-readable mediums of example 19, wherein acting on the comparing comprises taking a performance action.

Example 23 includes the one or more tangible, non-transitory computer-readable mediums of example 22, wherein the performance action comprises allocating additional capability.

Example 24 includes the one or more tangible, non-transitory computer-readable mediums of example 22, wherein the performance action comprises reducing capability.

Example 25 includes a method of providing telemetry in a data center, comprising: communicatively coupling a network; providing a data center orchestration function; and allocating a data structure, comprising a network function virtualization definition (NFVD) instance, the NFVD instance comprising a definition for instantiating a virtual network function (VNF) on a host platform, including a telemetry fingerprint policy description (TFPD) for the VNF, wherein the TFPD comprises information to collect telemetry data selected from a set of available telemetry data for the host platform.

Example 26 includes the method of example 25, wherein the TFPD comprises a plurality of context-specific fingerprints.

Example 27 includes the method of example 26, wherein the context is selected from a group consisting of performance, security, and reliability.

Example 28 includes the method of example 25, further comprising: provisioning a VNF instance according to the VNFD; and applying the TFPD to build a fingerprint policy for the VNF instance.

Example 29 includes the method of example 28, wherein building the VNF policy comprises receiving from the host platform a list of available metrics for the hardware platform.

Example 30 includes the method of example 29, wherein provisioning the VNF instance comprises querying a plurality of host platforms, and filtering out host platforms that will not provide telemetry required by the TFPD.

Example 31 includes the method of any of examples 25-30, wherein the instructions are further to cause the hardware platform to receive telemetry from the VNF instance, compare the telemetry to a reference fingerprint, and to act on the comparing.

Example 32 includes the method of example 31, wherein acting on the comparing comprises taking a security action.

Example 33 includes the method of example 32, wherein acting on the comparing comprises taking a reliability action.

Example 34 includes the method of example 32, wherein acting on the comparing comprises taking a performance action.

Example 35 includes the method of example 34, wherein the performance action comprises allocating additional capability.

Example 36 includes the method of example 34, wherein the performance action comprises reducing capability.

Example 37 includes an apparatus comprising means for performing the method of any of examples 25-36.

Example 38 includes the apparatus of example 37, wherein the memory comprises machine-readable instructions, that when executed cause the apparatus to perform the method of any of examples 25-36.

Example 39 includes the apparatus of any of examples 37-38, wherein the apparatus is a computing system.

Example 40 includes at least one computer readable medium comprising instructions that, when executed, implement a method or realize an apparatus as claimed in any of examples 25-39.

Example 41 includes a data center host platform, comprising: a hardware platform comprising telemetry collection capability; a host fabric interface to communicatively couple the hardware platform to a network; logic to run a virtual network function (VNF) instance on the hardware platform; and a telemetry collector to: receive a telemetry fingerprint policy specific to the VNF instance; collect telemetry from the hardware platform for the VNF according to the telemetry fingerprint policy; and report the telemetry to an orchestrator via the HFI.

Example 42 includes the data center host platform of example 41, wherein collecting telemetry comprises tagging telemetry data with a tag specific to the VNF instance.

What is claimed is:

1. A data center orchestrator, comprising:
a hardware platform;
a host fabric interface to communicatively couple the orchestrator to a network;
an orchestrator engine to provide a data center orchestration function; and
a data structure, comprising a network function virtualization definition (NFVD) instance, the NFVD instance comprising a definition for instantiating a virtual network function (VNF) on a host platform, including a telemetry fingerprint policy description (TFPD) for the VNF, wherein the TFPD comprises information to collect telemetry data selected from a set of available telemetry data for the host platform.

2. The data center orchestrator of claim 1, wherein the TFPD comprises a plurality of context-specific fingerprints.

3. The data center orchestrator of claim 2, wherein the context is selected from a group consisting of performance, security, and reliability.

4. The data center orchestrator of claim 1, further comprising a policy rationalization module to:
provision a VNF instance according to the VNFD; and
apply the TFPD to build a fingerprint policy for the VNF instance.

5. The data center orchestrator of claim 4, wherein building the VNF policy comprises receiving from the host platform a list of available metrics for the hardware platform.

6. The data center orchestrator of claim 5, wherein provisioning the VNF instance comprises querying a plurality of host platforms, and filtering out host platforms that will not provide telemetry required by the TFPD.

7. The data center orchestrator of claim 1, further comprising a fingerprint analytics module to receive telemetry from the VNF instance, compare the telemetry to a reference fingerprint, and to act on the comparing.

8. The data center orchestrator of claim 7, wherein acting on the comparing comprises taking a security action.

9. The data center orchestrator of claim 7, wherein acting on the comparing comprises taking a reliability action.

10. The data center orchestrator of claim 7, wherein acting on the comparing comprises taking a performance action.

11. The data center orchestrator of claim 10, wherein the performance action comprises allocating additional capability.

12. The data center orchestrator of claim 10, wherein the performance action comprises reducing capability.

13. One or more tangible, non-transitory computer-readable storage mediums having stored thereon instructions to cause a hardware platform to:
communicatively couple a network;
provide a data center orchestration function; and
allocate a data structure, comprising a network function virtualization definition (NFVD) instance, the NFVD instance comprising a definition for instantiating a virtual network function (VNF) on a host platform, including a telemetry fingerprint policy description (TFPD) for the VNF, wherein the TFPD comprises information to collect telemetry data selected from a set of available telemetry data for the host platform.

14. The one or more tangible, non-transitory computer-readable mediums of claim 13, wherein the TFPD comprises a plurality of context-specific fingerprints.

15. The one or more tangible, non-transitory computer-readable mediums of claim 14, wherein the context is selected from a group consisting of performance, security, and reliability.

16. The one or more tangible, non-transitory computer-readable mediums of claim 13, wherein the instructions are further to cause the hardware platform to:
provision a VNF instance according to the VNFD; and
apply the TFPD to build a fingerprint policy for the VNF instance.

17. The one or more tangible, non-transitory computer-readable mediums of claim 16, wherein building the VNF policy comprises receiving from the host platform a list of available metrics for the hardware platform.

18. The one or more tangible, non-transitory computer-readable mediums of claim 17, wherein provisioning the VNF instance comprises querying a plurality of host platforms, and filtering out host platforms that will not provide telemetry required by the TFPD.

19. The one or more tangible, non-transitory computer-readable mediums of claim 13, wherein the instructions are further to cause the hardware platform to receive telemetry from the VNF instance, compare the telemetry to a reference fingerprint, and to act on the comparing.

20. The one or more tangible, non-transitory computer-readable mediums of claim 19, wherein acting on the comparing comprises taking a security action.

21. The one or more tangible, non-transitory computer-readable mediums of claim 19, wherein acting on the comparing comprises taking a reliability action.

22. The one or more tangible, non-transitory computer-readable mediums of claim 19, wherein acting on the comparing comprises taking a performance action.

23. The one or more tangible, non-transitory computer-readable mediums of claim 22, wherein the performance action is selected from a group consisting of allocating additional capability and reducing capability

24. A data center host platform, comprising:
a hardware platform comprising telemetry collection capability;
a host fabric interface to communicatively couple the hardware platform to a network;
logic to run a virtual network function (VNF) instance on the hardware platform; and
a telemetry collector to:
receive a telemetry fingerprint policy specific to the VNF instance;
collect telemetry from the hardware platform for the VNF according to the telemetry fingerprint policy; and
report the telemetry to an orchestrator via the HFI.

25. The data center host platform of claim 24, wherein collecting telemetry comprises tagging telemetry data with a tag specific to the VNF instance.
